(19) United States
(12) Patent Application Publication
(10) Pub. No.: US 2006/0256253 A1
(43) Pub. Date: Nov. 16, 2006

(54) Liquid crystal display

(76) Inventors: Dae-Jin Park, Incheon-si (KR); Sang-Il Kim, Yongin-si (KR)

Correspondence Address: CANTOR COLBURN, LLP, 55 GRIFFIN ROAD SOUTH, BLOOMFIELD, CT, 06002, US

(21) Appl. No.: 11/327,033

(22) Filed: Jan. 5, 2006

(30) Foreign Application Priority Data
May 10, 2005 (KR) 10-2005-0038896

(51) Int. Cl. G02F 1/1335

(52) U.S. Cl. 349/61

(57) ABSTRACT

A liquid crystal display includes an LCD panel assembly that has a backlight unit with color converters for coloring light from a light source for color display. The brightness of the LCD is improved because color filters, which are a major cause of light loss, are not used.

### CROSS REFERENCE TO RELATED APPLICATION

This application claims priority to and the benefit of Korean Patent Application No. 10-2005-0038896, filed on May 10, 2005, which is hereby incorporated by reference for all purposes as if fully set forth herein.

### BACKGROUND OF THE INVENTION

1. Field of the Invention

The present invention relates to a liquid crystal display that uses color converters with a backlight to realize a color display.

2. Discussion of the Background

An LCD is a type of flat panel display device that includes a pair of panels, each having electrodes on their inner surfaces and a dielectric anisotropy liquid crystal layer interposed between the panels. The variation of the voltage difference between the field generating electrodes changes the transmittance of light passing through the LCD. Images are created by controlling the voltage difference between the electrodes. The transmittance of light is determined by phase retardation originating from the optical characteristics of liquid crystal when the light passes the liquid crystal layer. The phase retardation is determined by the dielectric anisotropy liquid crystal and by controlling the cell gap between the two panels.

The most common LCD in use today is a thin film transistor (TFT) LCD. In a TFT LCD, one of the two panels is provided with as many TFTs as there are pixels displayed, to switch the voltage applied to the field generating electrodes.

Typical color LCDs have color filters including the three primary colors, red, green, and blue, to realize color image display. The color images are obtained by controlling the transmittance of the light passing through the respective color filters.

The drawback of typical color LCDs is that a lot of light is lost when light emitted from a light source passes through polarizing plates and the color filters. Compensation films and the like may be used to compensate such light loss, but the use of compensation films leads to an increase in the production cost of the LCD. Light will still be absorbed by the color filters despite the use of compensation films in the LCD. The absorption of light places a limit on improving the brightness of an LCD.

### SUMMARY OF THE INVENTION

This invention provides an LCD that uses color converters to convert the light from a backlight to color, thereby omitting the use of light absorbing color filters.

Additional features of the invention will be set forth in the description which follows, and in part will be apparent from the description, or may be learned by practice of the invention.

The present invention discloses an LCD including a liquid crystal panel assembly and a backlight unit. The backlight unit includes a light source and color converters.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a schematic cross-sectional view of an LCD according to an exemplary embodiment of the present invention.

FIG. 2 shows a layout view of a TFT array panel according to an exemplary embodiment of the present invention.

FIG. 3 shows a schematic cross-sectional view cut along III-III′ of FIG. 2.

FIG. 4 shows a schematic cross-sectional view showing arrangements of a black matrix and color filters employed in an LCD according to an exemplary embodiment of the present invention.

### DETAILED DESCRIPTION OF THE ILLUSTRATED EMBODIMENTS

The LCD of the present invention uses color converters instead of color filters for color display. Light loss caused by the color filters is stopped and the brightness of the LCD is improved. The production cost of the LCD is reduced because separate brightness enhancing films are unnecessary. Production efficiency is improved because the difficulties encountered in arranging the color filters and the black matrix in the manufacturing process are removed.

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

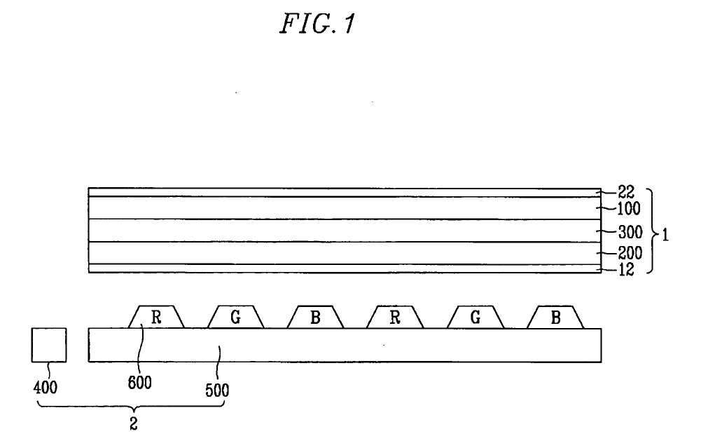

An LCD according to an exemplary embodiment of the present invention will now be described in detail with reference to FIG. 1.

FIG. 1 is a schematic cross-sectional view of an LCD according to an exemplary embodiment of the present invention.

As shown in FIG. 1, the LCD may include an LC panel assembly 1 and a backlight unit 2. The LC panel assembly 1 may include a TFT array panel 100 and a common electrode panel 200 facing each other, with a liquid crystal layer 300 between them.

Polarizers 12 and 22 may be individually attached to outer surfaces of the TFT array panel 100 and the common electrode panel 200.

In an exemplary embodiment of the present invention, panels 100 and 200 are not provided with a color filter. Accordingly, the LC panel assembly 1 is incapable of realizing color display by itself and can display only black and white.

The backlight unit 2 may be positioned under the LC panel assembly 1 and may include a light source 400, a light guiding plate 500, and color converters 600.

The light source 400 may be positioned under the light guiding plate 500 or at a side of the light guiding plate 500. FIG. 1 shows the light source 400 placed at the side of the light guiding plate 500.

The light guiding plate 500 may direct light emitted from the light source 400 toward the LC panel assembly 1. For this purpose, a reflection plate or a specular waveguide may be positioned on a bottom surface of the light guiding plate 500 or at a side thereof. If the light guiding plate 500 uses a reflection plate, the position of the reflection plate may be varied depending on the position of the light source 400 and the LC panel assembly 1. In an exemplary embodiment, the reflection plate is positioned at a lower side of the light guiding plate 500. A specular waveguide is shown in the exemplary embodiment shown in FIG. 1. The specular waveguide directs light from the light source 400 to the LC panel assembly 1 by total internal reflection.

The color converters 600 may be positioned on the light guiding plate 500. The light emitted from the light source 400 may pass through the color converters 600 and enter the LC panel assembly 1. Colors are displayed when the light passes through the color converters 600. The color converters 600 may include at least three types of converters, including red, green, and blue.

The color converters 600 color the light emitted from the backlight unit 2 so that the LC panel assembly 1 realizes color display without using color filters.

In an exemplary embodiment, violet edge light with a wavelength of about 380 nm to about 420 nm is emitted from the light source 400. Cold cathode fluorescent lamps is (CCFLs) or light emitting diodes (LEDs) may be used as the light source 400. In an exemplary embodiment, at least two or more light sources are preferable. The light source 400 may be an edge type light, positioned at a side of the light guiding plate 500, or the light source may be a rear type light, positioned under the light guiding plate 500.

An exemplary embodiment uses a specular waveguide as the light guiding plate 500. The light guiding plate 500 converts the light emitted from the side light type light source 400 to a uniform surface light and then directs the surface light to the LC panel assembly 1. The light guiding plate 500 may have a refractive index of about 1.5.

Equation 1 is derived from Snell's Law:
nₐᵢᵣ sin θₐᵢᵣ=n_{wvg} sin θ_{wvg,} (1)

In equation 1, nₐᵢᵣ is a refractive index of air (i.e., 1.0), θₐᵢᵣ is an angle formed between the normal for the light guiding plate 500 and the light emitted from the light source 400 in the air, n_{wvg} is a refractive index of the light guiding plate 500 (i.e., about 1.5), and θ_{wvg} is an angle formed between the normal for the light guiding plate 500 and the light emitted from the light source 400 within the light guiding plate 500.

An incident angle of the light for total internal reflection is calculated by equation 2:
nₐᵢᵣ sin 90=n_{wvg} sin θc, (2)
where θc is a critical angle for the total internal reflection.

When each value is practically applied to equation 2, θc is about 42°. Accordingly, in the case where the light is output to the air at the incident angle of about 42° or more, total internal reflection is generated.

The light guiding plate 500 may be made of a flexible material. In an exemplary embodiment, the LC panel assembly 1 and portions of the backlight unit 2 are made of a flexible material.

The color converters 600 used in this exemplary embodiment include three types of color converters, respectively exhibiting red, green, and blue. Each color converter contains a fluorescent compound. The color converters 600 may be arranged in various manners. In an exemplary embodiment, one type of color converters 600 are arranged in a row, and a different type of color converters 600 are arranged on either side thereof. The manufacturing process for this arrangement is especially convenient. In another exemplary embodiment, each of the color converters may come in contact with adjacent color converters. Different arrangements are also possible.

An exemplary embodiment uses red, green, and blue color converters 600, but any combination of colors may be used. Color converters of one, two, three, four, five, six or more colors may also be used. Any combination of colors with any number of colors may be used.

The principles of coloring the light emitted from the light source 400 will now be described.

When violet light is applied to the fluorescent compound included in the color converters 600, the light is absorbed and then converted to visible light. The visible light may be red, green, or blue.

In an exemplary embodiment, the color converters 600 are positioned on the light guiding plate 500 and the reflective index of each color converter is larger than that of the light guiding plate 500, i.e., over about 1.5.

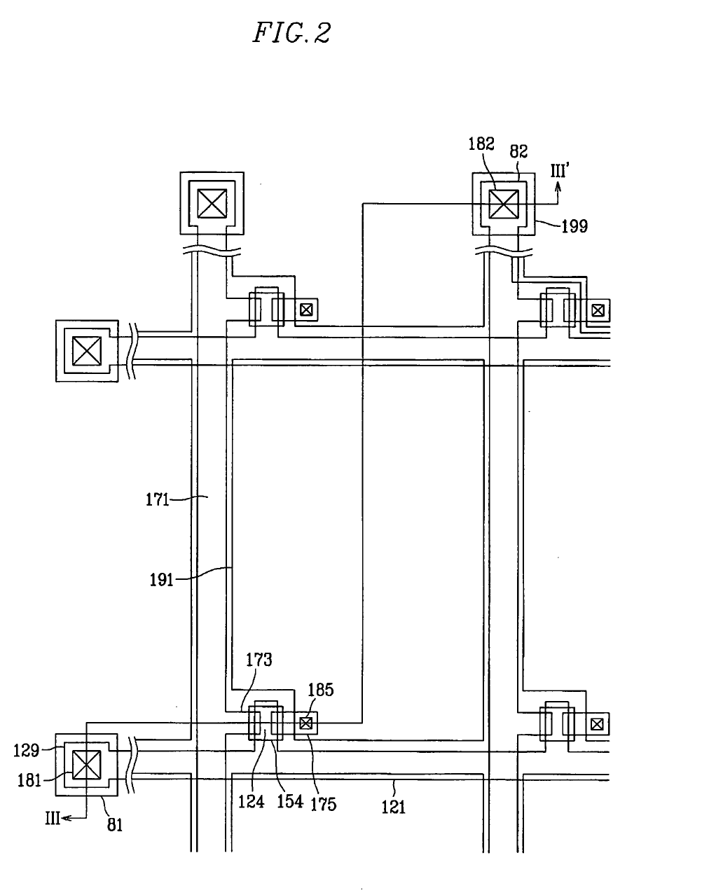

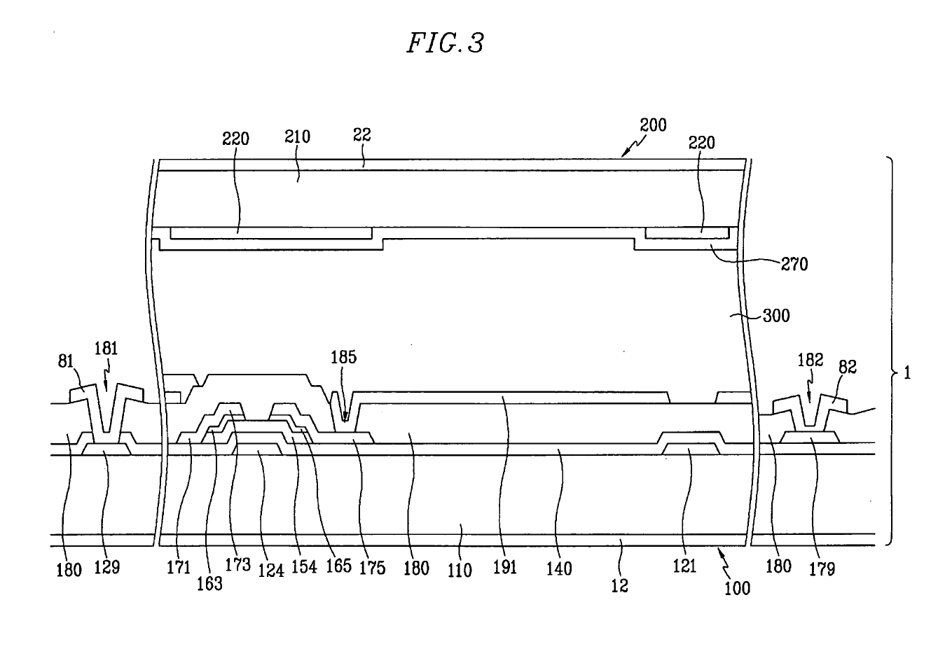

The TFT array panel 100 and the common electrode panel 200 of the present invention will now be described in detail with reference to FIG. 2 and FIG. 3.

FIG. 2 is a layout view of a TFT array panel according to an exemplary embodiment of the present invention. FIG. 3 is a schematic cross-sectional view cut along III-III′ of FIG. 2.

As shown in FIG. 1, an LCD according to this exemplary embodiment of the present invention includes a TFT array panel 100 and a common electrode panel 200 facing each other, with a liquid crystal layer 300 interposed between them. The LCD may further include a spacer (not shown) that forms and maintains a cell gap between the panels 100 and 200.

As shown in FIG. 2, the TFT array panel 100 contains a specific number of pixel regions. The pixel regions are defined by intersections of gate lines 121 and data lines 171 arranged in a matrix. Each pixel region is provided with a TFT that is connected to one of the gate lines 121 and one of the data lines 171, and a pixel electrode 191 that is electrically connected to the TFT. The pixel electrode 191 is formed of a transparent conductor layer.

The common electrode panel 200 opposite the TFT array panel 100 includes a black matrix 220, in which aperture regions corresponding to the pixel regions are formed. A common electrode 270 is formed on the black matrix 220. The common electrode 270 may be formed directly on the black matrix 220 as shown in FIG. 3. Otherwise, prior to the formation of the common electrode 270, an organic layer may be formed on the black matrix 220 to planarize the top surface of the black matrix 220.

The structure of the TFT array panel 100 will now be described in more detail.

A plurality of gate lines 121 are formed on an insulating substrate 110 made of transparent glass or plastic.

The gate lines 121 for transmitting gate signals extend in a substantially horizontal direction. Each gate line 121 includes a plurality of gate electrodes 124 protruding upward. Each gate line 121 also includes an end portion 129 having a relatively large dimension to be connected to a different layer or an external device. Gate drivers (not shown) for generating the gate signals may be mounted on a flexible printed circuit (not shown) attached to the substrate 110, mounted directly on the substrate 110, or integrated into the substrate 110. In this exemplary embodiment, the gate lines 121 are directly connected to the gate drivers.

The gate lines 121 may be made of aluminum (Al), an Al alloy, silver (Ag), a Ag alloy, copper (Cu), a Cu alloy, molybdenum (Mo), a Mo alloy, chrome (Cr), titanium (Ti), or tantalum (Ta). The gate lines 121 may be configured as double-layered structures, in which two conductive layers (not shown) having different physical properties are included. In this exemplary embodiment, one of the two layers is made of a low resistivity metal, such as Al, an Al alloy, Ag, an Ag alloy, or the like, in order to reduce delay of the signals or voltage drop in the gate lines 121. The other layer is made of a material having prominent physical, chemical, and electrical contact properties with materials such as indium tin oxide (ITO) or indium zinc oxide (IZO). The other layer may be made of a Mo alloy, Cr, Ta, Ti or the like. An example of a desirable combination of the two layers are a lower Cr layer with an upper Al or Al alloy layer. Another example of a desirable combination is a lower Al or Al alloy layer with an upper Mo or Mo alloy layer. Other metals and conductors besides the above-listed materials may be used for the formation of the gate lines 121.

All of the lateral sides of the gate lines 121 may slope in the range from about 30° to about 80° to the surface of the substrate 110.

A gate insulating layer 140 made of nitride silicon (SiNx) or oxide silicon (SiO₂), is formed on the gate lines 121.

A plurality of island-shaped semiconductors 154 made of hydrogenated amorphous silicon (abbreviated as “a-Si”) or polysilicon are formed on the gate insulating layer 140. Each semiconductor 154 is placed on the gate electrode 124.

A plurality of island-shaped ohmic contacts 163 and 165 are formed on the semiconductors 154. The ohmic contacts 163 and 165 may be made of N+ hydrogenated amorphous silicon that is highly doped with N-type impurities such as phosphorus (P), or silicide. A set of the ohmic contacts 163 and 165 are placed on the semiconductor 154.

The lateral sides of the semiconductors 154 and the ohmic contacts 163 and 165 slope in the range from about 30° to about 80° to the surface of the substrate 110.

A plurality of data lines 171 and a plurality of drain electrodes 175 are formed on the ohmic contacts 163 and 165 and the gate insulating layer 140.

The data lines 171 for transmitting data signals extend in a substantially vertical direction to be crossed with the gate lines 121. Each data line 171 includes a plurality of source electrodes 173 extending toward the respective gate electrodes 124. Each data line 171 also includes an end portion 179 having a relatively large dimension to be connected to a different layer or an external device. Data drivers (not shown) for generating the data signals may be mounted on a flexible printed circuit (not shown) attached to the substrate 110, mounted directly on the substrate 110, or integrated into the substrate 110. In FIG. 3, the data lines 171 are shown as being directly connected to the gate drivers.

The drain electrodes 175 are separated from the data lines 171. The drain electrodes 175 are opposite to the source electrodes 173. The drain electrodes 175 and the source electrodes 173 are centered on the gate electrodes 124.

A gate electrode 124, a source electrode 173, a drain electrode 175, and a semiconductor 154 form a thin film transistor (TFT). A TFT channel is formed in the semiconductor 154 positioned between the source electrode 173 and the drain electrode 175.

The data lines 171 and the drain electrodes 175 are preferably made of a refractory metal, such as Mo, Cr, Ta, Ti, or alloys thereof, and may be configured as a multi-layered structure including a refractory metal layer (not shown) and a low resistivity conductive layer (not shown). An example of a desirable multi-layered structure is a lower Mo or Mo alloy layer with an upper Al or Al alloy layer. Another example of a desirable multi-layered structure is a lower Mo or Mo alloy layer, an intermediate Al or Al alloy layer, and an upper Mo or Mo alloy layer. Other metals and conductors besides the materials listed above can be used for the formation of the data lines 171 and the drain electrodes 175.

The lateral sides of the data lines 171 and the drain electrodes 175 may slope in the range from about 30° to about 80° to the surface of the substrate 110.

The ohmic contacts 163 and 165 exist between the underlying semiconductors 154 and the overlying data lines 171 and between the overlying drain electrodes 175 and the underlying semiconductors 154, to reduce contact resistance. The semiconductors 154 are partially exposed at places where the data lines 171 and the drain electrodes 175 do not cover them, as well as between the source electrodes 173 and the drain electrodes 175.

A passivation layer 180 is formed on the data lines 171, the drain electrodes 175, and the exposed portions of the semiconductors 154. The top surface of the passivation layer 180 may be flat. The passivation layer 180 may be made of an inorganic insulator such as SiNx or SiO₂. The passivation layer 180 may also be made of an organic insulator having photosensitivity and a dielectric constant of below 4.0. The passivation layer 180 may be configured as a double-layered structure including a lower inorganic insulator layer and an upper organic insulator layer. This double-layered structure guarantees a better insulating property and shields the exposed semiconductors 154 from damage.

The passivation layer 180 is provided with a plurality of contact holes 182 and 185 through which the end portions 179 of the data lines 171 and the drain electrodes 175 are exposed. A plurality of contact holes 181 are formed in the passivation layer 180 through which the gate insulating layer 140 and the end portions 129 of the gate lines 121 are exposed.

A plurality of pixel electrodes 191 and a plurality of contact assistants 81 and 82 are formed on the passivation layer 180. The pixel electrode 191 and the contact assistants 81 and 82 may be made of a transparent conductive material such as ITO or IZO, or a reflective metal such as Ag, a Ag alloy, Cr, or a Cr alloy.

The pixel electrodes 191 are physically and electrically connected to the drain electrodes 175 through the contact holes 185 to receive data voltages from the drain electrodes 175. The pixel electrodes 191 use the data voltages to generate electric fields in cooperation with the common electrode 270 to determine the orientations of liquid crystal molecules in the liquid crystal layer 300 interposed between the pixel electrodes 191 and the common electrode 270. The polarization of light passing through the liquid crystal layer 300 is varied according to the orientation of the liquid crystal molecules. The pixel electrode 191 and the common electrode 270 together form a liquid crystal capacitor capable of storing the applied voltage after the TFT is turned off.

The LC panel assembly 1 may be formed in in-plane switching mode, in which the common electrode 270 and the pixel electrodes 191 are formed in one panel.

The contact assistants 81 and 82 are connected to the end portions 129 of the gate lines 121 and the end portions 179 of the data lines 171 through the contact holes 181 and 182, respectively. The contact assistants 81 and 82 protect the exposed end portions 129 and 179 and also supplement the adhesion between the exposed end portions 129 and 179 and exterior devices.

The structure of the common electrode panel 200 will now be described in more detail.

A black matrix 220 is formed on an insulating substrate 210 made of transparent glass or plastic. The black matrix 220 is formed to correspond to the gate lines 121, the data lines 171, and the TFTs of the TFT array panel 100. The black matrix 220 is made of a material capable of blocking light. Metals such as Cr or an oxide of such metals may be used for the black matrix 220.

A common electrode 270 made of a transparent conductive material such as ITO or IZO is formed on the black matrix 220. An organic layer (not shown) may be formed on the black matrix 220 to planarize the top surface of the black matrix 220 prior to the formation of the common electrode 270.

Polarizers 12 and 22 are individually attached to the outer surfaces of the two panels 100 and 200. The polarization axes of the polarizers 12 and 22 are parallel or perpendicular to each other in this exemplary embodiment, but may be arranged in a different manner.

A liquid crystal layer 300 is interposed between panels 100 and 200. Any type of liquid crystal may be employed in the liquid crystal layer 300. Examples include, but are not limited to, twisted nematic (TN) mode and vertical alignment (VA) mode.

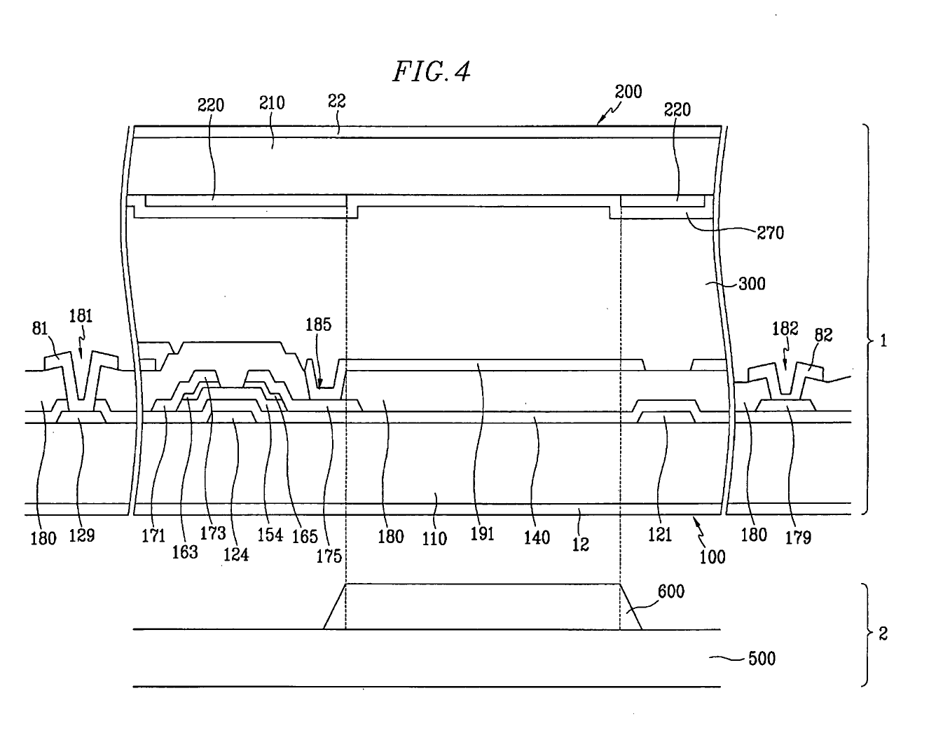

FIG. 4 shows a schematic cross-sectional view showing arrangements of a black matrix and color filters employed in an LCD according to an exemplary embodiment of the present invention.

As shown in FIG. 4, each color converter 600 may have a dimension capable of covering an aperture region where a black matrix 220 is not applied. The adjacent color converters 600 may come in contact with each other.

It will be apparent to those skilled in the art that various modifications and variation can be made in the present invention without departing from the spirit or scope of the invention. It is intended that the present invention cover the modifications and variations of this invention provided they come within the scope of the appended claims and their equivalents.

What is claimed is:

1. A liquid crystal display, comprising:
a liquid crystal panel assembly; and
a backlight unit,
wherein the backlight unit includes a light source and color converters.

2. The liquid crystal display of claim 1,
wherein each of the color converters includes a fluorescent compound.

3. The liquid crystal display of claim 2,
wherein the color converters are comprised of three types of color converters, and
wherein the types of color converters comprise red, green, and blue.

4. The liquid crystal display of claim 1,
wherein the light source produces violet light.

5. The liquid crystal display of claim 4,
wherein the violet light has a wavelength in the range of about 380 nm to about 420 nm.

6. The liquid crystal display of claim 4,
wherein the color converters convert the violet light to red light, green light, and blue light.

7. The liquid crystal display of claim 4,
wherein the light source comprises a CCFL or an LED.

8. The liquid crystal display of claim 1,
wherein the liquid crystal panel assembly and the backlight unit are made of a flexible material.

9. The liquid crystal display of claim 1,
wherein the liquid crystal panel assembly displays black and white.

10. The liquid crystal display of claim 1,
wherein the liquid crystal panel assembly does not include color filters or brightness enhancers.

11. The liquid crystal display of claim 1,
wherein the backlight unit includes a light guiding plate.

12. The liquid crystal display of claim 11,
wherein the light source is positioned at a side of the light guiding plate or beneath the light guiding plate.

13. The liquid crystal display of claim 11,
wherein the light guiding plate comprises a reflection plate.

14. The liquid crystal display of claim 11,
wherein the light guiding plate comprises a specular waveguide.

15. The liquid crystal display of claim 14,
wherein light from the light source is output to the air at an incident angle of about 42 degrees or more to generate total internal reflection in the specular waveguide.

16. The liquid crystal display of claim 11,
wherein a refractive index of each color converter is larger than that of the light guiding plate.

17. The liquid crystal display of claim 11,
wherein the color converters are formed on the light guiding plate, and
wherein types of color converters exhibiting the same color are arranged in a row.

18. The liquid crystal display of claim 1,
wherein the liquid crystal panel assembly comprises a black matrix and aperture regions where the black matrix is not applied, and
wherein the color converters are arranged to correspond to the respective aperture regions.

19. The liquid crystal display of claim 1,
wherein each of the color converters comes in contact with adjacent color converters.

20. The liquid crystal display of claim 1,
further comprising polarizing plates attached to outer surfaces of the liquid crystal panel assembly.
